(19) United States
(12) Patent Application Publication
(10) Pub. No.: US 2025/0330988 A1
(43) Pub. Date: Oct. 23, 2025

(54) SYSTEMS AND METHODS FOR REPORTING USER EQUIPMENT CAPABILITY

(71) Applicant: ZTE CORPORATION, Shenzhen (CN)

(72) Inventors: Yang ZHANG, Shenzhen (CN); Bo GAO, Shenzhen (CN); Meng MEI, Shenzhen (CN); Xiaolong GUO, Shenzhen (CN); Ke YAO, Shenzhen (CN); Yu Ngok LI, Shenzhen (CN)

(73) Assignee: ZTE CORPORATION, Shenzhen (CN)

(21) Appl. No.: 19/249,362

(22) Filed: Jun. 25, 2025

Related U.S. Application Data
(63) Continuation of application No. PCT/CN2023/076563, filed on Feb. 16, 2023.

(51) Int. Cl. H04W 72/21; H04L 5/00

(52) U.S. Cl. CPC H04W 72/21; H04L 5/0048

(57) ABSTRACT

Presented are systems and methods for reporting capability of a user equipment (UE) for simultaneous physical uplink shared channel (PUSCH) transmission in multi-transmission reception point (TRP) operation. A wireless communication device may simultaneously transmit a first Physical Uplink Shared Channel (PUSCH) transmission and a second PUSCH transmission. The first PUSCH transmission can be associated with a first User Equipment (UE) capability report. The second PUSCH transmission can be associated with a second UE capability report.

### CROSS-REFERENCE TO RELATED APPLICATION

This application claims the benefit of priority under 35 U.S.C. § 120 as a continuation of PCT Patent Application No. PCT/CN2023/076563, filed on Feb. 16, 2023, the disclosure of which is incorporated herein by reference in its entirety.

### TECHNICAL FIELD

The disclosure relates generally to wireless communications, including but not limited to systems and methods for reporting capability of a user equipment (UE) for simultaneous physical uplink shared channel (PUSCH) transmission in multi-transmission reception point (TRP) operation.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device may simultaneously transmit a first Physical Uplink Shared Channel (PUSCH) transmission and a second PUSCH transmission. The first PUSCH transmission can be associated with a first User Equipment (UE) capability report. The second PUSCH transmission can be associated with a second UE capability report.

In some embodiments, the first PUSCH transmission and second PUSCH transmission can be associated with different transmission layers, respectively. In some embodiments, the first PUSCH transmission and second PUSCH transmission can be fully or partially overlapped with each other in at least one of a frequency domain or a time domain. In some embodiments, each of the first PUSCH transmission and second PUSCH transmission can be associated with a respective beam state or a respective spatial relation. In some embodiments, each of the first PUSCH transmission and second PUSCH transmission can be associated with a respective Sounding Reference Signal (SRS) resource set.

In some embodiments, the first PUSCH transmission and second PUSCH transmission can be associated with one or more identical transmission layers or identical Demodulation Reference Signal (DMRS) ports. In some embodiments, the first PUSCH transmission and second PUSCH transmission can be fully or partially overlapped with each other in at least one of a frequency domain or a time domain. In some embodiments, each of the first PUSCH transmission and second PUSCH transmission can be associated with a respective beam state or a respective spatial relation. In some embodiments, each of the first PUSCH transmission and second PUSCH transmission can be associated with a respective Sounding Reference Signal (SRS) resource set. Each of the first PUSCH transmission and second PUSCH transmission can be configured as a codebook-based PUSCH transmission.

In some embodiments, the first UE capability report may comprise at least one of: a value of a maximum transmission layer for the first PUSCH transmission, a number of antenna ports for the first PUSCH transmission, a maximum number of SRS resources per SRS resource set for the first PUSCH transmission, a mode of UL full power transmission for the first PUSCH transmission, or a maximum coherence of antenna ports for the first PUSCH transmission. The second UE capability report may comprise at least one of: a value of a maximum transmission layer for the second PUSCH transmission, a number of antenna ports for the second PUSCH transmission, a maximum number of SRS resources per SRS resource set for the second PUSCH transmission, a mode of UL full power transmission for the second PUSCH transmission, or a maximum coherence of antenna ports for the second PUSCH transmission.

In some embodiments, each of the first PUSCH transmission and second PUSCH transmission can be configured as a non-codebook-based PUSCH transmission. The first UE capability report may comprise at least one of: a value of a maximum transmission layer for the first PUSCH transmission, a maximum number of SRS resources per SRS resource set for the first PUSCH transmission, or a maximum number of simultaneous transmitted SRS resources at one symbol for the first PUSCH transmission. The second UE capability report may comprise at least one of: a value of a maximum transmission layer for the second PUSCH transmission, a maximum number of SRS resources per SRS resource set for the second PUSCH transmission, or a maximum number of simultaneous transmitted SRS resources at one symbol for the second PUSCH transmission.

In some embodiments, the first UE capability report may comprise at least one of: a value of a maximum transmission layer for the first or second PUSCH transmission, a combination value of maximum transmission layers for the first and second PUSCH transmissions, a number of antenna ports for the first or second PUSCH transmission, a combination number of antenna ports for the first and second PUSCH transmissions, a maximum number of SRS resources per SRS resource set for the first or second PUSCH transmission, a mode of UL full power transmission for the first or second PUSCH transmission, or a maximum coherence of antenna ports for the first or second PUSCH transmission. The second UE capability report may comprise at least one of: a value of a maximum transmission layer for the first or second PUSCH transmission, a combination value of maximum transmission layers for the first and second PUSCH transmissions, a number of antenna ports for the first or second PUSCH transmission, a combination number of antenna ports for the first and second PUSCH transmissions, a maximum number of SRS resources per SRS resource set for the first or second PUSCH transmission, a mode of UL full power transmission for the first or second PUSCH transmission, or a maximum coherence of antenna ports for the first or second PUSCH transmission.

In some embodiments, the first UE capability report may comprise at least one of: a value of a maximum transmission layer for the first or second PUSCH transmission, a combination value of maximum transmission layers for the first and second PUSCH transmissions, a maximum number of SRS resources per SRS resource set for the first or second PUSCH transmission, a maximum number of simultaneous transmitted SRS resources at one symbol for the first or second PUSCH transmission, or a combination value of maximum number of simultaneous transmitted SRS resources at one symbol for the first or second PUSCH transmission. The second UE capability report may comprise at least one of: a value of a maximum transmission layer for the first or second PUSCH transmission, a combination value of maximum transmission layers for the first and second PUSCH transmissions, a maximum number of SRS resources per SRS resource set for the first or second PUSCH transmission, a maximum number of simultaneous transmitted SRS resources at one symbol for the first or second PUSCH transmission, or a combination value of maximum number of simultaneous transmitted SRS resources at one symbol for the first or second PUSCH transmission.

In some embodiments, the wireless communication device may send at least one of the first UE capability report or the second UE capability report to a wireless communication node. The sent first or second UE capability report may indicate or can be associated with at least one of: an uplink TCI state associated with a CSI-RS set; a parameter “resourceType” of a corresponding SRS resource being set to “aperiodic,” “semi-persistent,” or “periodic;” an indication field of a DCI indicative of whether to transmit a corresponding SRS resource or PUSCH transmission; or an indication field of a DCI indicative of whether to transmit all SRS resources in a corresponding SRS resource set.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a spatial domain modulation (SDM) scheme based single-DCI scheduled simultaneous PUSCH transmission, in accordance with some embodiments of the present disclosure;

FIG. 4 illustrates an example implementation of a single frequency network (SFN) scheme based single-DCI scheduled simultaneous PUSCH transmission, in accordance with some embodiments of the present disclosure; and

FIG. 5 illustrates a flow diagram of an example method for reporting capability of a user equipment (UE), in accordance with an embodiment of the present disclosure.

### DETAILED DESCRIPTION

### 1. Mobile Communication Technology and Environment

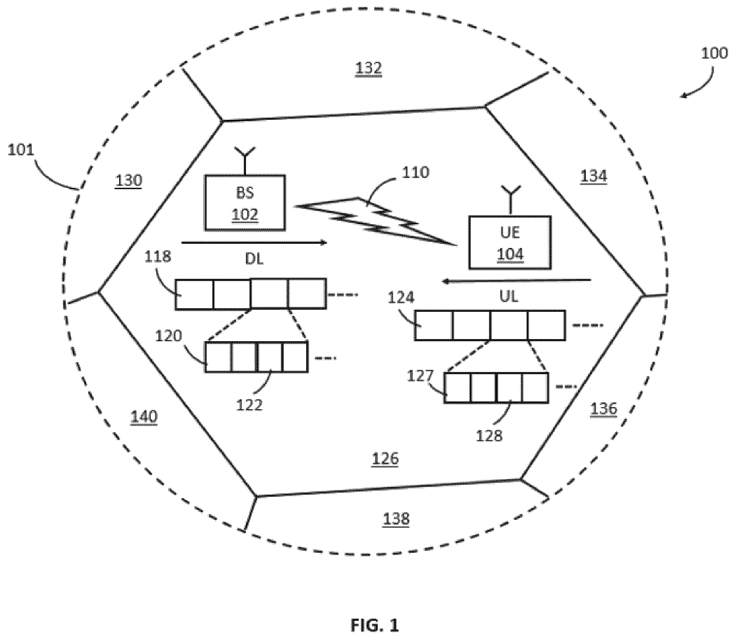

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

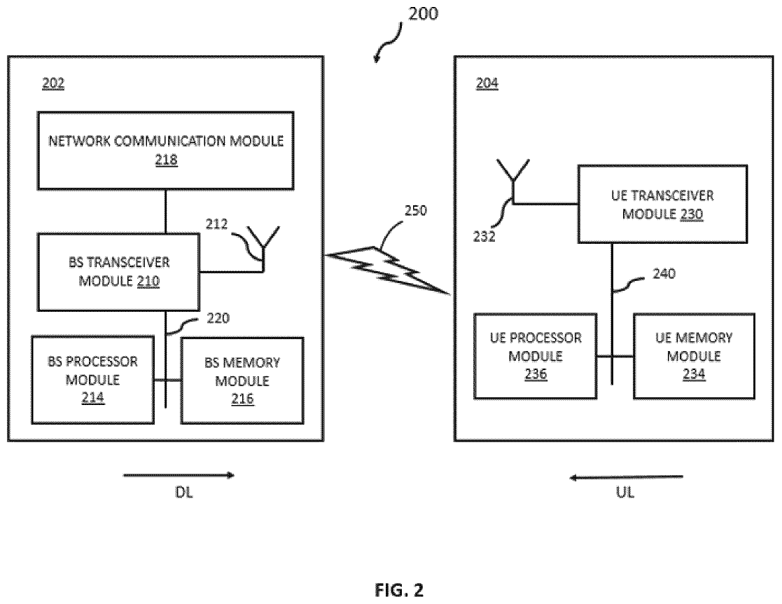

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Reporting Capability of a User Equipment (UE) for Simultaneous PUSCH Transmission in Multi-TRP Operation

In a 5G NR system, several transmission schemes of multiple transmission reception point (MTRP) operation may be supported for uplink (UL) transmissions on top of single transmission reception point (STRP) operation to improve a reliability and throughput of UL channels or signals. However, due to the restriction of the current UE capability, multiple uplink transmissions can only be performed as non-overlapped in time domain even though the UE is equipped with more than one panel, which can be a bottleneck for the reliability and throughput of whole system once multi-TRP based uplink transmission can be supported.

With the evolution of a mobile communication technology, the UE equipped with multiple panels can be supported to simultaneously transmit more than one uplink transmission. On the other hand, due to different channel conditions of the link between multiple panels of the UE and multiple TRPs during MTRP operation, some transmission parameters (e.g., transmission precoder or spatial relation indication) may be dedicated between the panel and TRP for better performance. Besides, for the sake of schedule flexibility, support of dynamic switching between single-TRP and MTRP can be taken into consideration. Furthermore, since a bitsize of an indication field in DCI is determined by a radio resource control (RRC) configuration and a UE capability reporting, it may vary according to different cases. Correspondingly, it may lead to DCI overhead dynamically changed but which can be avoided.

Based on the above discussion, some specific issues may need to be addressed for the case of simultaneous uplink transmission across multiple UE panels and towards different TRPs, including: (i) how to determine a maximum bitsize of an indication field in DCI for subscriber data management (SDM) scheme based simultaneous physical uplink shared channel (PUSCH) transmission in MTRP operation; or (ii) how to determine a maximum bitsize of an indication field in DCI for system frame number (SFN) scheme based simultaneous PUSCH transmission in MTRP operation.

Since PUSCH transmission towards a single TRP only, the UE may use a same indicated information for a repeated transmission across multiple slots, which means that each of these transmissions may use the same spatial relation and transmission precoder. Both codebook based and non-codebook based PUSCH transmission can be supported.

For a codebook based PUSCH transmission, PUSCH can be scheduled by downlink control information (DCI) (e.g., DCI format 0_0, DCI format 0_1, or DCI format 0_2) or radio resource control (RRC) signaling (e.g., higher layer parameter ConfiguredGrantConfig). The UE may determine its PUSCH transmission precoder based on sounding reference signal (SRS) resource indicator (SRI), transmit precoding matrix indicator (TPMI), and/or a transmission rank. The SRI, the TPMI, and/or the transmission rank can be given by some fields in DCI (e.g.,, SRS resource indicator field, second SRS resource indicator field, second precoding information and number of layers field, or precoding information and number of layers field) or given by some higher layer parameters in a RRC signaling (e.g., srs-ResourceIndicator, srs-ResourceIndicator2, precodingAndNumberOfLayers, or precodingAndNumberOfLayers2).

For a non-codebook based PUSCH transmission, in contrast to the codebook based scheme, the UE may determine its precoder and transmission rank based on the SRI when multiple sounding reference signal (SRS) resources are configured in a SRS resource set. The SRI can be given by the SRS resource indicator in DCI. Specifically, the UE may use one or multiple SRS resources for SRS transmission in a SRS resource set. A maximum number of SRS resources which can be configured to the UE for simultaneous transmission in the same symbol and a maximum number of SRS resources can be UE capabilities. The SRS resources transmitted simultaneously may occupy the same RBs. In some embodiments, only one SRS port for each SRS resource can be configured. In some embodiments, only one SRS resource set can be configured with higher layer parameter usage in SRS-ResourceSet set to ‘nonCodebook’. A maximum number of SRS resources in one SRS resource set that can be configured for non-codebook based PUSCH transmission can be 4. The indicated SRI in slot n can be associated with the most recent transmission of SRS resource(s) identified by the SRI. The SRS transmission can be prior to the PDCCH carrying the SRI. After that, the UE can calculate the precoder used for the transmission of SRS based on measurement of an associated non-zero-power (NZP) channel status information reference signal (CSI-RS) resource. The UE selection of a precoder (and the number of layers) for each scheduled PUSCH may be modified by the network (in case multiple SRS resources are configured). The UE may transmit PUSCH using the same antenna ports as the SRS port(s) in the SRS resource(s) indicated by SRI given by DCI.

5G NR may include a number of multiple-input/multiple-out (MIMO) features that facilitate utilization of a large number of antenna elements at base station for both sub-6 GHz (frequency range 1, FR1) and over-6 GHz (frequency range 2, FR2) frequency bands, plus one of the MIMO features that supports for multi-TRP operation. The key point of this functionality can be to collaborate with multiple TRPs to transmit or receive data by the UE to improve transmission performance. As NR is in a process of commercialization, various aspects that require further enhancements can be identified from real deployment scenarios. In some embodiments, simultaneous uplink transmissions can be supported and performed by multi-panel UE in multi TRPs (MTRP) operation, which can be beneficial to improve a throughput of uplink transmission.

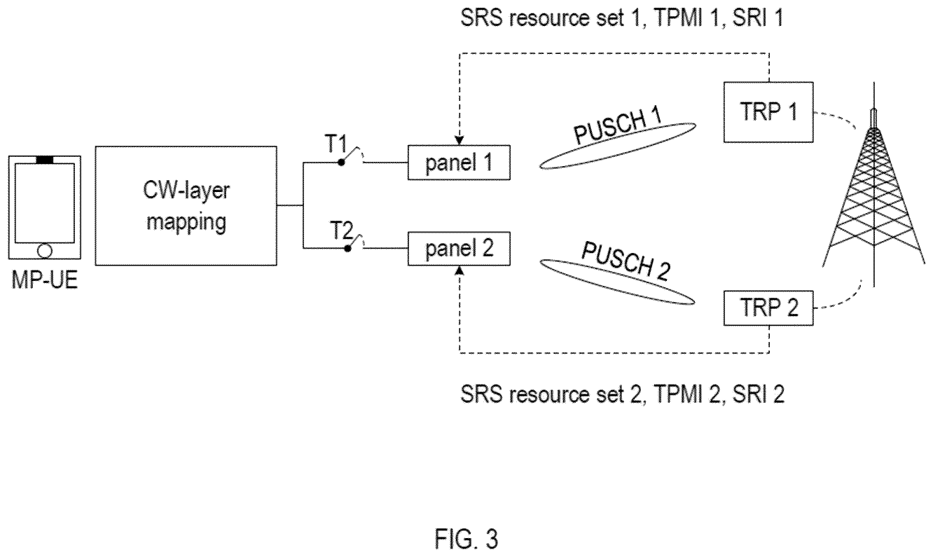

Furthermore, a spatial domain modulation (SDM) scheme based single downlink control information (DCI) scheduled simultaneous physical uplink shared channel (PUSCH) transmission in MTRP operation can be introduced and fulfilled in 5G NR (as shown in FIG. 3). During a MTRP operation (e.g., both T1 and T2 are closed), different layers of the PUSCH are transmitted to different TRPs and separately associated with different SRS resource sets. The precoder, rank, and/or selected SRS resource(s) of PUSCH transmitted from each panel can be indicated by the first and the second TPMI/SRI fields respectively. When the UE switches to STRP operation (e.g., either T1 or T2 is closed), PUSCH transmitted from one panel can be associated with one SRS resource set. The precoder, the rank, and/or the selected SRS resource(s) of the PUSCH transmitted from one panel can be indicated by a first or a second transmit precoding matrix index (TPMI)/SRI field.

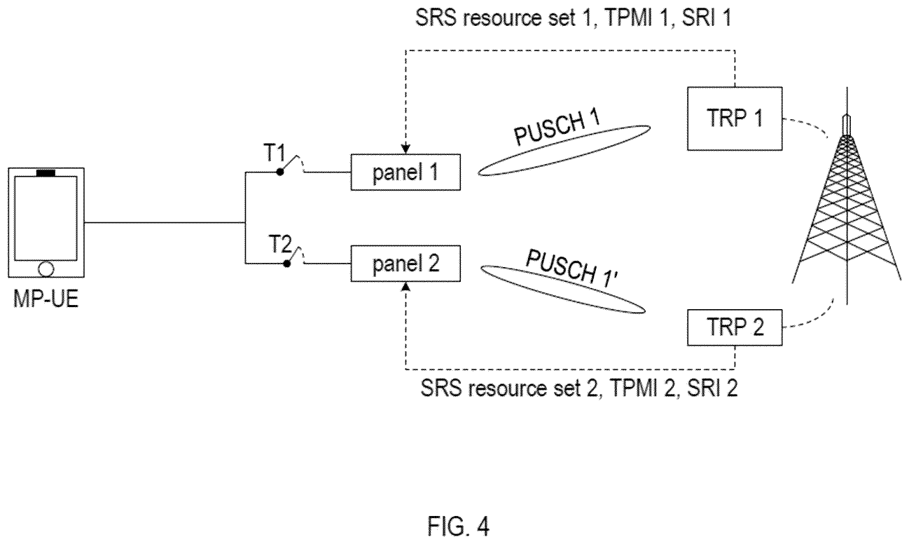

Moreover, a single frequency network (SFM) scheme based single DCI scheduled simultaneous PUSCH transmission in MTRP operation can be introduced and fulfilled in 5G NR (as shown in FIG. 4). During a MTRP operation (e.g., both T1 and T2 are closed), all of the same layers/DMRS ports of one PUSCH can be transmitted from different UE panels and towards to different TRPs simultaneously. Besides, these PUSCH transmissions can be associated with different SRS resource sets. The precoder, the rank, and/or the selected SRS resource(s) of each PUSCH transmission from each panel can be indicated by the first and the second TPMI/SRI fields respectively. When the UE switches to STRP operation (e.g., either T1 or T2 is closed), PUSCH transmission can be from one panel is associated with one SRS resource set. The precoder, the rank, and/or the selected SRS resource(s) of the PUSCH transmitted from one panel can be indicated by the first or the second TPMI/SRI field.

In some embodiments, a “simultaneous uplink transmission scheme” can be equivalent to multiple uplink transmissions which can be fully or partially overlapped in time domain. The simultaneous uplink transmissions can be associated with different panel/TRP ID. These simultaneous uplink transmissions can be scheduled by a single DCI or multiple DCI. Beside, whether the UE supports the “simultaneous uplink transmission scheme” can be reported as the UE optional capability.

In some embodiments, a “TRP” can be equivalent to at least one of: a SRS resource set, a spatial relation, a power control parameter set, a transmission configuration indicator (TCI) state, a CORESET, a CORESETPoolIndex, a physical cell index (PCI), a sub-array, a code division multiplexing (CDM) group of DMRS ports, a group of CSI-RS resources, or channel measurement resource (CMR) set.

In some embodiments, a “UE panel” can be equivalent to at least one of: a UE capability value set, an antenna group, an antenna port group, a beam group, a sub-array, a SRS resource set, a spatial relation, a group of DMRS ports, a CDM group, or a panel mode.

In some embodiments, a definition of “beam state” can be equivalent to at least one of: a quasi-co-location (QCL) state, a transmission configuration indicator (TCI) state, a spatial relation (also called as spatial relation information), a reference signal (RS), a spatial filter, or a precoding. Furthermore, a “beam state” can be also called as “beam.”

A definition of “Tx beam” can be equivalent to at least one of: a QCL state, a TCI state, a spatial relation state, a DL reference signal, a UL reference signal, a Tx spatial filter, or a Tx precoding. A definition of “Rx beam” can be equivalent to at least one of: a QCL state, a TCI state, a spatial relation state, a spatial filter, a Rx spatial filter, or a Rx precoding. A definition of “beam ID” can be equivalent to at least one of: a QCL state index, a TCI state index, a spatial relation state index, a reference signal index, a spatial filter index, or a precoding index.

A spatial filter can be either UE-side or gNB-side one. The spatial filter can be also called as spatial-domain filter. A “spatial relation” can include one or more reference RSs, which is used to represent the same or quasi-co “spatial relation” between targeted “RS or channel” and the one or more reference RSs. A “spatial relation” may indicate at least one of: a beam, a spatial parameter, or a spatial domain filter.

A “QCL state” can include one or more reference RSs and their corresponding QCL type parameters. The QCL type parameters may include at least one of the following aspect or combination: [1] Doppler spread, [2] Doppler shift, [3] delay spread, [4] average delay, [5] average gain, and [6] Spatial parameter (which is also called as spatial Rx parameter). A “TCI state” can be equivalent to “QCL state”. There can be the following definitions for “QCL-TypeA”, “QCL-TypeB”, “QCL-TypeC”, and “QCL-TypeD”.
“QCL-TypeA”: {Doppler shift, Doppler spread, average delay, delay spread}
“QCL-TypeB”: {Doppler shift, Doppler spread}
“QCL-TypeC”: {Doppler shift, average delay}
“QCL-TypeD”: {Spatial Rx parameter}

In some embodiments, a RS may comprise/include channel state information reference signal (CSI-RS), synchronization signal block (SSB) (which is also called as SS/PBCH), demodulation reference signal (DMRS), sounding reference signal (SRS), and physical random access channel (PRACH). Furthermore, the RS may include/comprise at least a DL reference signal and/or a UL reference signaling.

A DL RS may include/comprise at least a CSI-RS, a SSB, and/or a DMRS (e.g., DL DMRS). A UL RS may include/comprise at least a SRS, a DMRS (e.g., UL DMRS), and/or PRACH. A “UL signal” can be a PUCCH, a PUSCH, or a SRS. A “DL signal” can be a PDCCH, a PDSCH, or a CSI-RS.

The first and the second SRS resource sets can be respectively the ones with lower and higher srs-ResourceSetId of the two SRS resources sets configured by higher layer parameter srs-ResourceSetToAddModList or srs-ResourceSetToAddModListDCI-0-2, and associated with the higher layer parameter usage of value ‘nonCodeBook’ if txConfig=nonCodebook or ‘codeBook’ if txConfig=codebook. A PUSCH transmission can be equivalent to PUSCH transmission occasion. A TPMI field in DCI can be equivalent to at least one of: the Precoding information and number of layers field in DCI, or the Second Precoding information field in DCI. A SRI field in DCI can be equivalent to at least one of: the SRS resource indicator field in DCI, or the Second SRS resource indicator in DCI. The DCI can be equivalent to at least one of: DCI format 0_1, DCI format 0_2, or DCI format 0_0.

### IMPLEMENTATION EXAMPLE 1-1

### A UE Capability Reporting and its RRC Configuration for SDM Based Simultaneous PUSCH Transmission in MTRP Operation Under Certification Body (CB) Scheme

A UE can be scheduled to transmit at least one PUSCH transmission within one transmission occasion.

If the UE is scheduled to transmit more than one PUSCH transmission, each of these PUSCH transmissions may use different transmission layers. In some embodiments, a first PUSCH transmission can be associated with a first set of transmission layers. A second PUSCH transmission can be associated with a second set of transmission layers. In some embodiments, these PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions can be associated with a beam state or a spatial relation.

The UE can be configured with two SRS resource sets, which are configured in srs-ResourceSetToAddModList or srs-ResourceSetToAddModListDCI-0-2 with higher layer parameter usage in SRS-ResourceSet set to ‘codebook’. Each of PUSCH transmissions can be associated with one SRS resource set.

For a codebook based transmission scheme, the PUSCH transmission can be scheduled by DCI format 0_1, DCI format 0_2, or RRC only.

The UE may transmit one or more PUSCH transmissions based on a related UE capability report to the NW or the gNB. In some embodiments, the UE capability report can be dedicated to a PUSCH which can be associated with an SRS resource set under STRP transmission mode or SDM transmission mode, respectively.

The UE capability report of the PUSCH transmission may comprise at least one of the following parameters: a value of maximum transmission layers, a maximum number of antenna ports, a maximum number of SRS resources per SRS resource set, a mode of UL full power transmission, or a maximum coherence of antenna ports.

The capability parameter of maximum transmission layers can be configured by maxNumberMIMO-LayersCB-PUSCH. For STRP transmission mode, the value of maximum transmission layers can be at least one of 1, 2, 3, or 4. For SDM transmission mode, the value of maximum transmission layers can be 1 or 2. The value of maximum transmission layers for an SRS resource can be different from that of another SRS resource in the same SRS resource set.

The capability parameter of maximum number of antenna ports can be configured by maxNumberSRS-Ports-PerResource. For STRP transmission mode or SDM transmission mode, the value of maximum number of antenna ports can be 1, 2, or 4. The value of maximum number of antenna ports for an SRS resource can be different from that of another SRS resource in the same SRS resource set.

The capability parameter of the maximum number of SRS resources per SRS resource set can be configured by maxNumberSRS-ResourcePerSet. For STRP transmission mode or SDM transmission mode, the value of maximum number of SRS resources per SRS resource set can be at least one of 1, 2, 3, or 4. The value of maximum number of SRS resources for an SRS resource can be different from that of another SRS resource set.

The capability parameter of UL full power transmission mode can be configured by at least one of ul-FullPwrMode-r16, ul-FullPwrModel-r16, ul-FullPwrMode2-SRSConfig-diffNumSRSPorts-r16, or ul-FullPwrMode2-TPMIGroup-r16. For STRP transmission mode or SDM transmission mode, the capability of UL full power transmission mode for an SRS resource set can be different from that of another SRS resource set.

For STRP transmission mode or SDM transmission mode, the maximum coherence of antenna ports can be configured by pusch-TransCoherence. For STRP transmission mode or SDM transmission mode, the value of maximum coherence of antenna ports can be set to ‘fullCoherent’, ‘partialCoherent’ or ‘nonCoherent’. The maximum coherence of antenna ports for an SRS resource can be different from that of another SRS resource in the same SRS resource set.

### IMPLEMENTATION EXAMPLE 1-2

### A UE Capability Reporting and its RRC Configuration for SDM Based Simultaneous PUSCH Transmission in MTRP Operation Under National Certification Body (NCB) Scheme

A UE can be scheduled to transmit at least one PUSCH transmission within one transmission occasion.

If the UE is scheduled to transmit more than one PUSCH transmission, each of these PUSCH transmissions may use different transmission layers. In some embodiments, a first PUSCH transmission can be associated with a first set of transmission layers. A second PUSCH transmission can be associated with a second set of transmission layers. In some embodiments, these PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions can be associated with one beam state or spatial relation.

The UE can be configured with two SRS resource sets, which are configured in srs-ResourceSetToAddModList or srs-ResourceSetToAddModListDCI-0-2 with higher layer parameter usage in SRS-ResourceSet set to ‘noncodebook’. Each of PUSCH transmissions can be associated with one SRS resource set.

For a codebook based transmission scheme, the PUSCH transmission can be scheduled by DCI format 0_1, DCI format 0_2, or RRC only.

The UE may transmit one or more PUSCH transmissions based on a related UE capability report to the NW or the gNB. In some embodiments, the UE capability report can be dedicated to a PUSCH which can be associated with an SRS resource set under STRP transmission mode or SDM transmission mode, respectively.

The UE capability report of the PUSCH transmission may comprise at least one of the following parameters: a value of maximum transmission layers, a maximum number of SRS resources per SRS resource set, or a maximum number of simultaneous transmitted SRS resources at one symbol.

The capability parameter of maximum transmission layers can be configured by maxNumberMIMO-LayersNonCB-PUSCH. For STRP transmission mode, the value of maximum transmission layers can be at least one of 1, 2, 3, or 4. For SDM transmission mode, the value of maximum transmission layers can be 1 or 2. The value of maximum transmission layers for an SRS resource can be different from that of another SRS resource in the same SRS resource set.

The capability parameter of maximum number of SRS resources per SRS resource set can be configured by maxNumberSRS-ResourcePerSet. For STRP transmission mode or SDM transmission mode, the value of maximum number of SRS resources per SRS resource set can be 1, 2, 3, or 4. The value of maximum number of SRS resources per SRS resource set can be different from that of another SRS resource set.

The capability parameter of maximum number of simultaneous transmitted SRS resources at one symbol can be configured by maxNumberSimultaneousSRS-ResourceTx. For STRP transmission mode or SDM transmission mode, the value of maximum number of simultaneous transmitted SRS resources at one symbol can be 1, 2, 3, or 4. The value of maximum number of simultaneous transmitted SRS resources at one symbol for an SRS resource set can be different from that of another SRS resource set.

### IMPLEMENTATION EXAMPLE 1-3

### A UE Capability Reporting and its RRC Configuration for SFN Based Simultaneous PUSCH Transmission in MTRP Operation Under CB Scheme

A UE can be scheduled to transmit at least one PUSCH transmission within one transmission occasion.

If the UE is scheduled to transmit more than one PUSCH transmission, each of these PUSCH transmissions can be associated with one beam state or spatial relation. In some embodiments, a first PUSCH transmission can be associated with a first beam state or a spatial relation. A second PUSCH transmission can be associated with a second beam state or a spatial relation.

These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions may use the same transmission layers or DMRS ports.

The UE can be configured with two SRS resource sets, which can be configured in srs-ResourceSetToAddModList or srs-ResourceSetToAddModListDCI-0-2 with higher layer parameter usage in SRS-ResourceSet set to ‘codebook’. Each of PUSCH transmissions can be associated with a SRS resource set. For codebook based transmission scheme, the PUSCH transmission can be scheduled by DCI format 0_1 or DCI format 0_2.

The UE may transmit one or more PUSCH transmissions based on its related UE capability report to the NW or the gNB. The UE capability report can be dedicated to a PUSCH which can be associated with an SRS resource set under STRP transmission mode or SFN transmission mode, respectively. The UE capability report of the PUSCH transmission may comprise at least one of the following parameters: a value of maximum transmission layers, a maximum number of antenna ports, a maximum number of SRS resources per SRS resource set, a mode of UL full power transmission, or a maximum coherence of antenna ports.

The capability parameter of maximum transmission layers can be configured by maxNumberMIMO-LayersCB-PUSCH. For STRP transmission mode, the value of maximum transmission layers can be at least one of 1, 2, 3, or 4. For SFN transmission mode, the value of maximum transmission layers can be 1 or 2. The value of maximum transmission layers for an SRS resource can be different from that of another SRS resource in the same SRS resource set.

The capability parameter of maximum number of antenna ports can be configured by maxNumberSRS-Ports-PerResource. For STRP transmission mode or SFN transmission mode, the value of maximum number of antenna ports can be 1, 2, or 4. The value of maximum number of antenna ports for an SRS resource can be different from that of another SRS resource in the same SRS resource set.

The capability parameter of the maximum number of SRS resources per SRS resource set can be configured by maxNumberSRS-ResourcePerSet. For STRP transmission mode or SFN transmission mode, the value of maximum number of SRS resources per SRS resource set can be at least one of 1, 2, 3, or 4. The value of maximum number of SRS resources for an SRS resource can be different from that of another SRS resource set.

The capability parameter of UL full power transmission mode can be configured by at least one of ul-FullPwrMode-r16, ul-FullPwrModel-r16, ul-FullPwrMode2-SRSConfig-diffNumSRSPorts-r16, or ul-FullPwrMode2-TPMIGroup-r16. For STRP transmission mode or SFN transmission mode, the capability of UL full power transmission mode for an SRS resource set can be different from that of another SRS resource set.

For STRP transmission mode or SFN transmission mode, the maximum coherence of antenna ports can be configured by pusch-TransCoherence. For STRP transmission mode or SFN transmission mode, the value of maximum coherence of antenna ports can be set to ‘fullCoherent’, ‘partialCoherent’ or ‘nonCoherent’. The maximum coherence of antenna ports for an SRS resource can be different from that of another SRS resource in the same SRS resource set.

### IMPLEMENTATION EXAMPLE 1-4

### A UE Capability Reporting and its RRC Configuration for SFN Based Simultaneous PUSCH Transmission in MTRP Operation Under NCB Scheme

A UE can be scheduled to transmit at least one PUSCH transmission within one transmission occasion.

If the UE is scheduled to transmit more than one PUSCH transmission, each of these PUSCH transmissions can be associated with a beam state or a spatial relation. A first PUSCH transmission can be associated with a first beam state or a spatial relation. A second PUSCH transmission can be associated with a second beam state or a spatial relation. These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions may use the same transmission layers or DMRS ports.

The UE can be configured with two SRS resource sets, which can be configured in srs-ResourceSetToAddModList or srs-ResourceSetToAddModListDCI-0-2 with higher layer parameter usage in SRS-ResourceSet set to ‘nonCodebook’. Each of PUSCH transmissions can be associated with one SRS resource set. For codebook based transmission scheme, the PUSCH transmission can be scheduled by DCI format 0_1 or DCI format 0_2.

The UE may transmit one or more PUSCH transmissions based on its related UE capability report to the NW or the gNB. The UE capability report can be dedicated to a PUSCH which is associated with an SRS resource set under STRP transmission mode or SFN transmission mode, respectively. The UE capability report of the PUSCH transmission may comprise at least one of the following parameters: a value of maximum transmission layers, a maximum number of SRS resources per SRS resource set, or a maximum number of simultaneous transmitted SRS resources at one symbol.

The capability parameter of maximum transmission layers can be configured by maxNumberMIMO-LayersNonCB-PUSCH. For STRP transmission mode, the value of maximum transmission layers can be at least one of 1, 2, 3, or 4. For SFN transmission mode, the value of maximum transmission layers can be 1 or 2. The value of maximum transmission layers for an SRS resource can be different from that of another SRS resource in the same SRS resource set.

The capability parameter of maximum number of SRS resources per SRS resource set can be configured by maxNumberSRS-ResourcePerSet. For STRP transmission mode or SFN transmission mode, the value of maximum number of SRS resources per SRS resource set can be 1, 2, 3, or 4. The value of maximum number of SRS resources per SRS resource set can be different from that of another SRS resource set.

The capability parameter of maximum number of simultaneous transmitted SRS resources at one symbol can be configured by maxNumberSimultaneousSRS-ResourceTx. For STRP transmission mode or SFN transmission mode, the value of maximum number of simultaneous transmitted SRS resources at one symbol can be 1, 2, 3, or 4. The value of maximum number of simultaneous transmitted SRS resources at one symbol for an SRS resource set can be different from that of another SRS resource set.

### IMPLEMENTATION EXAMPLE 2-1

### A UE Capability Reporting and its RRC Configuration for SDM Based Simultaneous PUSCH Transmission in MTRP Operation Under CB Scheme

A UE can be scheduled to transmit at least one PUSCH transmission within one transmission occasion.

If the UE is scheduled to transmit more than one PUSCH transmission, each of these PUSCH transmissions may use different transmission layers. A first PUSCH transmission can be associated with a first set of transmission layers. A second PUSCH transmission can be associated with a second set of transmission layers. These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions can be associated with a beam state or a spatial relation.

The UE can be configured with two SRS resource sets, which can be configured in srs-ResourceSetToAddModList or srs-ResourceSetToAddModListDCI-0-2 with higher layer parameter usage in SRS-ResourceSet set to ‘codebook’. Each of PUSCH transmissions can be associated with one SRS resource set. For codebook based transmission scheme, the PUSCH transmission can be scheduled by DCI format 0_1, DCI format 0_2, or RRC only.

The UE may transmit one or more PUSCH transmissions based on its related UE capability report to the NW or the gNB. The UE capability report can be dedicated to a PUSCH transmission which associated with an SRS resource set under STRP transmission mode and/or SDM transmission mode. The UE capability report of the PUSCH transmission may comprise at least one of the following parameters: a value of maximum transmission layers, a combination of maximum transmission layers for SDM transmission mode, a maximum number of antenna ports, a combination of maximum antenna ports for SDM transmission mode, a maximum number of SRS resources per SRS resource set, a mode of UL full power transmission, or a maximum coherence of antenna ports.

The capability parameter of maximum transmission layers can be configured by maxNumberMIMO-LayersCB-PUSCH. For STRP transmission mode, the value of maximum transmission layers of a PUSCH transmission can be at least one of 1, 2, 3, or 4. The maximum layers combination for SDM transmission mode can be derived from the maximum layer combination for STRP transmission mode. For example, if the maximum transmission layers for STRP transmission is 2, the maximum layer combination for SDM transmission can be {1+1}. If the maximum transmission layers for STRP transmission is 3, the maximum layer combination for SDM transmission can be {1+2} or {2+1}. If the maximum transmission layers for STRP transmission is 4, the maximum layer combination for SDM transmission can be {2+2}.

For SDM transmission mode, the value of maximum transmission layers of a PUSCH transmission can be 1 or 2. The value of maximum transmission layers for an SRS resource can be different from that of another SRS resource in the same SRS resource set.

For SDM transmission mode, the combination of maximum transmission layers can be at least one of {1+1}, {1+2}, {2+1}, or {2+2}. The maximum transmission layers for STRP transmission mode can be the sum of the maximum layer combination for SDM transmission mode. For example, if the maximum layer combination for SDM transmission is {1+1}, the maximum transmission layers for STRP transmission can be 2. If the maximum layer combination for SDM transmission is {1+2} or {2+1}, the maximum transmission layers for STRP transmission can be 3. If the maximum layer combination for SDM transmission is {2+2}, the maximum transmission layers for STRP transmission can be 4.

The capability parameter of maximum number of antenna ports can be configured by maxNumberSRS-Ports-PerResource. For STRP transmission mode, the value of maximum number of antenna ports can be 1, 2, or 4. The maximum number of antenna ports for SDM transmission mode can be derived from the maximum number of antenna ports for STRP transmission mode. For example, if the maximum number of antenna ports for STRP transmission is 2, the combination of antenna ports for SDM transmission can be {1+1}. If the maximum number of antenna ports for STRP transmission is 4, the combination of antenna ports for SDM transmission can be {2+2}. For SDM transmission mode, the value of maximum number of antenna ports can be 1, 2, or 4. The value of maximum number of antenna ports for an SRS resource can be different from that of another SRS resource in the same SRS resource set.

For SDM transmission mode, the combination of antenna ports can be at least one of: {1+1}, {1+2}, {2+1}, {2+2}, {1+4}, {4+1}, {2+4}, {4+2}, or {4+4}. The maximum number of antenna ports for STRP transmission mode can be the sum of the combination of antenna ports for SDM transmission mode. For example, if the combination of antenna ports for SDM transmission is {1+1}, the maximum number of antenna ports for STRP transmission mode can be 2. If the combination of antenna ports for SDM transmission is {1+2} or {2+1}, the maximum number of antenna ports for STRP transmission mode can be 3. If the combination of antenna ports for SDM transmission is {2+2}, the maximum number of antenna ports for STRP transmission mode can be 4.

The capability parameter of the maximum number of SRS resources per SRS resource set can be configured by maxNumberSRS-ResourcePerSet. For STRP transmission mode or SDM transmission mode, the value of maximum number of SRS resources per SRS resource set can be at least one of 1, 2, 3, or 4. The value of maximum number of SRS resources for an SRS resource can be different from that of another SRS resource set.

The capability parameter of UL full power transmission mode can be configured by at least one of ul-FullPwrMode-r16, ul-FullPwrMode1-r16, ul-FullPwrMode2-SRSConfig-diffNumSRSPorts-r16, or ul-FullPwrMode2-TPMIGroup-r16. For STRP transmission mode or SDM transmission mode, the capability of UL full power transmission mode for an SRS resource set can be different from that of another SRS resource set.

For STRP transmission mode or SDM transmission mode, the maximum coherence of antenna ports can be configured by pusch-TransCoherence. For STRP transmission mode or SDM transmission mode, the value of maximum coherence of antenna ports can be set to ‘fullCoherent’, ‘partialCoherent’ or ‘nonCoherent’. The maximum coherence of antenna ports for an SRS resource can be different from that of another SRS resource in the same SRS resource set.

### IMPLEMENTATION EXAMPLE 2-2

### A UE Capability Reporting and its RRC for SDM Based Simultaneous PUSCH Transmission in MTRP Operation Under NCB Scheme

A UE can be scheduled to transmit at least one PUSCH transmission within one transmission occasion.

If the UE is scheduled to transmit more than one PUSCH transmission, each of these PUSCH transmissions may use different transmission layers. A first PUSCH transmission can be associated with a first set of transmission layers. A second PUSCH transmission can be associated with a second set of transmission layers. These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions are transmitted with same or different RV.

If the UE is scheduled to transmit more than one PUSCH transmission, each of these PUSCH transmissions can be associated with a beam state or a spatial relation.

The UE can be configured with two SRS resource sets, which can be configured in srs-ResourceSetToAddModList or srs-ResourceSetToAddModListDCI-0-2 with higher layer parameter usage in SRS-ResourceSet set to ‘nonCodebook’. Each of PUSCH transmissions can be associated with one SRS resource set.

For codebook based transmission scheme, the PUSCH transmission can be scheduled by DCI format 0_1, DCI format 0_2, or RRC only.

The UE may transmit one or more PUSCH transmissions based on its related UE capability report to the NW or the gNB. The UE capability report can be dedicated to a PUSCH transmission which associated with an SRS resource set under STRP transmission mode and/or SDM transmission mode. The UE capability report of the PUSCH transmission may comprise at least one of the following parameters: a value of maximum transmission layers, a combination of maximum transmission layers for SDM transmission mode, a maximum number of SRS resources per SRS resource set, a maximum number of simultaneous transmitted SRS resources at one symbol, or a combination of maximum number of simultaneous transmitted SRS resources at one symbol for SDM transmission mode.

The capability parameter of maximum transmission layers can be configured by maxNumberMIMO-LayersNonCB-PUSCH. For STRP transmission mode, the value of maximum transmission layers can be at least one of 1, 2, 3, or 4. The maximum layers combination for SDM transmission mode can be derived from the maximum layer combination for STRP transmission mode. For example, if the maximum transmission layers for STRP transmission is 2, the maximum layer combination for SDM transmission can be {1+1}. If the maximum transmission layers for STRP transmission is 3, the maximum layer combination for SDM transmission can be {1+2} or {2+1}. If the maximum transmission layers for STRP transmission is 4, the maximum layer combination for SDM transmission can be {2+2}.

For SDM transmission mode, the value of maximum transmission layers can be 1 or 2. The value of maximum transmission layers for an SRS resource can be different from that of another SRS resource in the same SRS resource set.

For SDM transmission mode, the combination of maximum transmission layers can be at least one of: {1+1}, {1+2}, {2+1}, or {2+2}. The maximum transmission layers for STRP transmission mode can be the sum of the maximum layer combination for SDM transmission mode. For example, if the maximum layer combination for SDM transmission is {1+1}, the maximum transmission layers for STRP transmission can be 2. If the maximum layer combination for SDM transmission is {1+2} or {2+1}, the maximum transmission layers for STRP transmission can be 3. If the maximum layer combination for SDM transmission is {2+2}, the maximum transmission layers for STRP transmission can be 4.

The capability parameter of maximum number of SRS resources per SRS resource set can be configured by maxNumberSRS-ResourcePerSet. For STRP transmission mode or SDM transmission mode, the value of maximum number of SRS resources per SRS resource set can be 1, 2, 3, or 4. The value of maximum number of SRS resources per SRS resource set can be different from that of another SRS resource set.

The capability parameter of maximum number of simultaneous transmitted SRS resources at one symbol can be configured by maxNumberSimultaneousSRS-ResourceTx. For STRP transmission mode, the value of maximum number of simultaneous transmitted SRS resources at one symbol can be 1, 2, 3, or 4. The combination of maximum number of simultaneous transmitted SRS resources at one symbol for SDM transmission mode can be derivated from that for STRP transmission mode. For example, if the maximum number of simultaneous transmitted SRS resources at one symbol for STRP transmission is 2, the combination of maximum number of simultaneous transmitted SRS resources at one symbol for SDM transmission can be {1+1}. If the maximum number of simultaneous transmitted SRS resources at one symbol for STRP transmission is 3, the combination of maximum number of simultaneous transmitted SRS resources at one symbol for SDM transmission can be {1+2} or {2+1}. If the maximum number of simultaneous transmitted SRS resources at one symbol for STRP transmission is 4, the combination of maximum number of simultaneous transmitted SRS resources at one symbol for SDM transmission can be {2+2}.

For SDM transmission mode, the value of maximum number of simultaneous transmitted SRS resources at one symbol can be 1, 2, 3, or 4. The value of maximum number of simultaneous transmitted SRS resources at one symbol for an SRS resource set can be different from that of another SRS resource set.

For SDM transmission mode, the combination of maximum number of simultaneous transmitted SRS resources at one symbol can be at least one of: {1+1}, {1+2}, {2+1}, {2+2}, {1+4}, {4+1}, {2+4}, {4+2}, or {4+4}. The maximum number of simultaneous transmitted SRS resources at one symbol for STRP transmission mode can be the sum of the combination of maximum number of simultaneous transmitted SRS resources at one symbol for SDM transmission mode. For example, if the combination of maximum number of simultaneous transmitted SRS resources at one symbol for SDM transmission is {1+1}, the maximum number of simultaneous transmitted SRS resources at one symbol can be 2. If the combination of maximum number of simultaneous transmitted SRS resources at one symbol for SDM transmission is {1+2} or {2+1}, the maximum number of simultaneous transmitted SRS resources at one symbol for STRP transmission mode can be 3. If the combination of maximum number of simultaneous transmitted SRS resources at one symbol for SDM transmission is {2+2}, the maximum number of simultaneous transmitted SRS resources at one symbol for STRP transmission mode can be 4.

### IMPLEMENTATION EXAMPLE 2-3

### A UE Capability Reporting and its RRC Configuration for SFN Based Simultaneous PUSCH Transmission in MTRP Operation Under CB Scheme

A UE can be scheduled to transmit at least one PUSCH transmission within one transmission occasion.

If the UE is scheduled to transmit more than one PUSCH transmission, each of these PUSCH transmissions can be associated with a beam state or a spatial relation. A first PUSCH transmission can be associated with a first beam state or a spatial relation. A second PUSCH transmission can be associated with a second beam state or a spatial relation. These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions may use the same transmission layers or DMRS ports.

The UE can be configured with two SRS resource sets, which can be configured in srs-ResourceSetToAddModList or srs-ResourceSetToAddModListDCI-0-2 with higher layer parameter usage in SRS-ResourceSet set to ‘codebook’. Each of PUSCH transmissions can be associated with one SRS resource set.

For codebook based transmission scheme, the PUSCH transmission can be scheduled by DCI format 0_1 or DCI format 0_2.

The UE may transmit one or more PUSCH transmissions based on its related UE capability report to the NW or the gNB. The UE capability report can be dedicated to a PUSCH transmission which associated with a SRS resource set under STRP transmission mode and/or SFN transmission mode. The UE capability report of the PUSCH transmission may comprise at least one of the following parameters: a value of maximum transmission layers, a combination of maximum transmission layers for SFN transmission mode, a maximum number of antenna ports, a combination of maximum antenna ports for SFN transmission mode, a maximum number of SRS resources per SRS resource set, a mode of UL full power transmission, or a maximum coherence of antenna ports.

The capability parameter of maximum transmission layers can be configured by maxNumberMIMO-LayersCB-PUSCH. For STRP transmission mode, the value of maximum transmission layers of a PUSCH transmission can be at least one of 1, 2, 3, or 4. The maximum layers combination for SFN transmission mode can be derived from the maximum layer combination for STRP transmission mode. For example, if the maximum transmission layers for STRP transmission is 2, the maximum layer combination for SFN transmission can be {1+1}. If the maximum transmission layers for STRP transmission is 4, the maximum layer combination for SFN transmission can be {2+2}. For SFN transmission mode, the value of maximum transmission layers for a PUSCH transmission can be 1 or 2. The value of maximum transmission layers for an SRS resource can be different from that of another SRS resource in the same SRS resource set.

For SFN transmission mode, the combination of maximum transmission layers can be at least one of {1+1} or {2+2}. The maximum transmission layers for STRP transmission mode can be the sum of the maximum layer combination for SFN transmission mode. For example, if the maximum layer combination for SFN transmission is {1+1}, the maximum transmission layers for STRP transmission can be 2. If the maximum layer combination for SFN transmission is {2+2}, the maximum transmission layers for STRP transmission can be 4.

The capability parameter of maximum number of antenna ports can be configured by maxNumberSRS-Ports-PerResource. For STRP transmission mode, the value of maximum number of antenna ports can be 1, 2, or 4. The maximum number of antenna ports for SFN transmission mode can be derived from the maximum number of antenna ports for STRP transmission mode. For example, if the maximum number of antenna ports for STRP transmission is 2, the combination of antenna ports for SFN transmission can be {1+1}. If the maximum number of antenna ports for STRP transmission is 4, the combination of antenna ports for SFN transmission can be {2+2}. For SFN transmission mode, the value of maximum number of antenna ports can be 1, 2, or 4. The value of maximum number of antenna ports for an SRS resource can be different from that of another SRS resource in the same SRS resource set.

For SEN transmission mode, the combination of antenna ports can be at least one of: {1+1}, {1+2}, {2+1}, {2+2}, {1+4}, {4+1}, {2+4}, {4+2}, or {4+4}. The maximum number of antenna ports for STRP transmission mode can be the sum of the combination of antenna ports for SFN transmission mode. For example, if the combination of antenna ports for SFN transmission is {1+1}, the maximum number of antenna ports for STRP transmission mode can be 2. If the combination of antenna ports for SFN transmission is {1+2} or {2+1}, the maximum number of antenna ports for STRP transmission mode can be 3. If the combination of antenna ports for SFN transmission is {2+2}, the maximum number of antenna ports for STRP transmission mode can be 4.

The capability parameter of the maximum number of SRS resources per SRS resource set can be configured by maxNumberSRS-ResourcePerSet. For STRP transmission mode or SFN transmission mode, the value of maximum number of SRS resources per SRS resource set can be at least one of 1, 2, 3, or 4. The value of maximum number of SRS resources for an SRS resource can be different from that of another SRS resource set.

The capability parameter of UL full power transmission mode can be configured by at least one of ul-FullPwrMode-r16, ul-FullPwrModel-r16, ul-FullPwrMode2-SRSConfig-diffNumSRSPorts-r16, or ul-FullPwrMode2-TPMIGroup-r16. For STRP transmission mode or SFN transmission mode, the capability of UL full power transmission mode for an SRS resource set can be different from that of another SRS resource set.

For STRP transmission mode or SFN transmission mode, the maximum coherence of antenna ports can be configured by pusch-TransCoherence. For STRP transmission mode or SFN transmission mode, the value of maximum coherence of antenna ports can be set to ‘fullCoherent’, ‘partialCoherent’ or ‘nonCoherent’. The maximum coherence of antenna ports for an SRS resource can be different from that of another SRS resource in the same SRS resource set.

### IMPLEMENTATION EXAMPLE 2-4

### A UE Capability Reporting and its RRC Configuration for SFN Based Simultaneous PUSCH Transmission in MTRP Operation When NCB Scheme

A UE can be scheduled to transmit at least one PUSCH transmission within one transmission occasion.

If the UE is scheduled to transmit more than one PUSCH transmission, each of these PUSCH transmissions can be associated with one beam state or spatial relation. A first PUSCH transmission can be associated with a first beam state or a spatial relation. A second PUSCH transmission can be associated with a second beam state or a spatial relation. These PUSCH transmissions can be fully or partially overlapped with each other in time domain and/or frequency domain. The PUSCH transmission can be at least one of: inter-slot based PUSCH transmission or intra-slot based PUSCH transmission. These PUSCH transmissions can be transmitted with same or different RV.

If the UE is scheduled to transmit more than one PUSCH transmission, each of these PUSCH transmissions may use the same transmission layers or DMRS ports.

The UE can be configured with two SRS resource sets, which can be configured in srs-ResourceSetToAddModList or srs-ResourceSetToAddModListDCI-0-2 with higher layer parameter usage in SRS-ResourceSet set to ‘codebook’. Each of PUSCH transmissions can be associated with one SRS resource set. For codebook based transmission scheme, the PUSCH transmission can be scheduled by DCI format 0_1 or DCI format 0_2.

The UE may transmit one or more PUSCH transmissions based on its related UE capability report to the NW or the gNB. The UE capability report can be dedicated to a PUSCH transmission which associated with an SRS resource set under STRP transmission mode and/or SDM transmission mode. The UE capability report of the PUSCH transmission may comprise at least one of the following parameters: a value of maximum transmission layers, a combination of maximum transmission layers for SDM transmission mode, a maximum number of SRS resources per SRS resource set, a maximum number of simultaneous transmitted SRS resources at one symbol, or a combination of maximum number of simultaneous transmitted SRS resources at one symbol for SDM transmission mode.

The capability parameter of maximum transmission layers can be configured by maxNumberMIMO-LayersNonCB-PUSCH. For STRP transmission mode, the value of maximum transmission layers can be at least one of 1, 2, 3, or 4. The maximum layers combination for SDM transmission mode can be derived from the maximum layer combination for STRP transmission mode. For example, if the maximum transmission layers for STRP transmission is 2, the maximum layer combination for SDM transmission can be {1+1}. If the maximum transmission layers for STRP transmission is 4, the maximum layer combination for SDM transmission can be {2+2}. For SDM transmission mode, the value of maximum transmission layers can be 1 or 2. The value of maximum transmission layers for an SRS resource can be different from that of another SRS resource in the same SRS resource set.

For SDM transmission mode, the combination of maximum transmission layers can be at least one of {1+1} or {2+2}. The maximum transmission layers for STRP transmission mode can be the sum of the maximum layer combination for SDM transmission mode. For example, if the maximum layer combination for SDM transmission is {1+1}, the maximum transmission layers for STRP transmission can be 2. If the maximum layer combination for SDM transmission is {2+2}, the maximum transmission layers for STRP transmission can be 4.

The capability parameter of maximum number of SRS resources per SRS resource set can be configured by maxNumberSRS-ResourcePerSet. For STRP transmission mode or SDM transmission mode, the value of maximum number of SRS resources per SRS resource set can be 1, 2, 3, or 4. The value of maximum number of SRS resources per SRS resource set can be different from that of another SRS resource set.

The capability parameter of maximum number of simultaneous transmitted SRS resources at one symbol can be configured by maxNumberSimultaneousSRS-ResourceTx. For STRP transmission mode, the value of maximum number of simultaneous transmitted SRS resources at one symbol can be 1, 2, 3, or 4. The combination of maximum number of simultaneous transmitted SRS resources at one symbol for SDM transmission mode can be derived from that for STRP transmission mode. For example, if the maximum number of simultaneous transmitted SRS resources at one symbol for STRP transmission is 2, the combination of maximum number of simultaneous transmitted SRS resources at one symbol for SDM transmission can be {1+1}. If the maximum number of simultaneous transmitted SRS resources at one symbol for STRP transmission is 4, the combination of maximum number of simultaneous transmitted SRS resources at one symbol for SDM transmission can be {2+2}. For SDM transmission mode, the value of maximum number of simultaneous transmitted SRS resources at one symbol can be 1, 2, 3, or 4. The value of maximum number of simultaneous transmitted SRS resources at one symbol for an SRS resource set can be different from that of another SRS resource set.

For SDM transmission mode, the combination of maximum number of simultaneous transmitted SRS resources at one symbol can be at least one of {1+1} or {2+2}. The maximum number of simultaneous transmitted SRS resources at one symbol for STRP transmission mode can be the sum of the combination of maximum number of simultaneous transmitted SRS resources at one symbol for SDM transmission mode. For example, if the combination of maximum number of simultaneous transmitted SRS resources at one symbol for SDM transmission is {1+1}, the maximum number of simultaneous transmitted SRS resources at one symbol can be 2. If the combination of maximum number of simultaneous transmitted SRS resources at one symbol for SDM transmission is {2+2}, the maximum number of simultaneous transmitted SRS resources at one symbol for STRP transmission mode can be 4.

### IMPLEMENTATION EXAMPLE 3-1

### A UE Capability Reporting of Disabling SRS Transmission for SDM Based Simultaneous PUSCH Transmission in MTRP Operation Under CB or NCB Scheme

A UE can be scheduled to transmit at least one PUSCH transmission within one transmission occasion.

If the UE is scheduled to transmit more than one PUSCH transmission, each of these PUSCH transmissions may use different transmission layers. A first PUSCH transmission can be associated with a first set of transmission layers. A second PUSCH transmission can be associated with a second set of transmission layers. These PUSCH transmissions can be fully or partially overlapped with each other in time domain and/or frequency domain. Furthermore, the PUSCH transmission can be at least one of: inter-slot based PUSCH transmission or intra-slot based PUSCH transmission. Furthermore, these PUSCH transmissions can be transmitted with same or different RV.

If the UE is scheduled to transmit more than one PUSCH transmission, each of these PUSCH transmissions can be associated with a beam state or a spatial relation.

The UE can be configured with two SRS resource sets, which can be configured in srs-ResourceSetToAddModList or srs-ResourceSetToAddModListDCI-0-2 with higher layer parameter usage in SRS-ResourceSet set to ‘beamManagement’, ‘codebook’, ‘nonCodebook’ or ‘antennaSwitching’. Each of PUSCH transmissions can be associated with one SRS resource set. The UE can be configured with one or more SRS resource configuration(s). The higher layer parameter resouceType can be set to at least one of: ‘aperiodic’, ‘semi-persistent’ or ‘periodic’. For codebook or non-codebook based transmission scheme, the PUSCH transmission can be scheduled by DCI format 0_1, DCI format 0_2, or RRC only.

The UE can be to report the status of at least one SRS resource from one SRS resource set or its related PUSCH transmission to the gNB side or NW side. The reporting can be associated with one UL TCI state which from one CSI-RS set. The SRS resource set of the SRS resource can be different from that of the CSI-RS set or UL TCI state. The higher layer parameter resouceType of the SRS resource can be set to at least one of: ‘aperiodic’, ‘semi-persistent’ or ‘periodic’. The transmission of the SRS resource cannot be transmitted by the UE, or the PUSCH transmission associated with the SRS resource cannot be transmitted by the UE. An indication field in DCI can be used to indicate whether the SRS resource or its related PUSCH transmission can be transmitted. The indication field can be UL-SCH indicator in the DCI. In terms of the value of the indication field, a value of “1” may indicate that the SRS resource can be transmitted or UL-SCH can be transmitted on the PUSCH, a value of “0” may indicate that the SRS resource may not be transmitted or UL-SCH may not be transmitted on the PUSCH. An indication field in DCI can be used to indicate whether all of the SRS resource(s) in the SRS resource set can be transmitted.

### IMPLEMENTATION EXAMPLE 3-2

### A UE Capability Reporting of Disabling SRS Transmission for SFN Based Simultaneous PUSCH Transmission in MTRP Operation Under CB or NCB Scheme

A UE can be scheduled to transmit at least one PUSCH transmission within one transmission occasion.

If the UE is scheduled to transmit more than one PUSCH transmission, each of these PUSCH transmissions can be associated with a beam state or a spatial relation. A first PUSCH transmission can be associated with a first beam state or a spatial relation. A second PUSCH transmission can be associated with a second beam state or a spatial relation. These PUSCH transmissions can be fully or partially overlapped with each other in time domain and/or frequency domain. Furthermore, the PUSCH transmission can be at least one of: inter-slot based PUSCH transmission or intra-slot based PUSCH transmission. Furthermore, these PUSCH transmissions can be transmitted with same or different RV.

If the UE is scheduled to transmit more than one PUSCH transmission, each of these PUSCH transmissions may use the same transmission layers or DMRS ports.

The UE can be configured with two SRS resource sets, which can be configured in srs-ResourceSetToAddModList or srs-ResourceSetToAddModListDCI-0-2 with higher layer parameter usage in SRS-ResourceSet set to ‘beamManagement’, ‘codebook’, ‘nonCodebook’ or ‘antennaSwitching’. Each of PUSCH transmissions can be associated with one SRS resource set.

For codebook based transmission scheme, the PUSCH transmission can be scheduled by DCI format 0_1 or DCI format 0_2.

The UE may report the status of at least one SRS resource from one SRS resource set or its related PUSCH transmission to the gNB side or NW side. The reporting can be associated with one UL TCI state which from one CSI-RS set. The SRS resource set of the SRS resource can be different from that of the CSI-RS set or UL TCI state. The higher layer parameter resouceType of the SRS resource can be set to at least one of: ‘aperiodic’, ‘semi-persistent’ or ‘periodic’. The transmission of the SRS resource cannot be transmitted by the UE, or the PUSCH transmission associated with the SRS resource cannot be transmitted by the UE. An indication field in DCI can be used to indicate whether the SRS resource or its related PUSCH transmission can be transmitted. The indication field can be UL-SCH indicator in the DCI. In terms of the value of the indication field, a value of “1” may indicate that the SRS resource can be transmitted or UL-SCH can be transmitted on the PUSCH, a value of “0” may indicate that the SRS resource cannot be transmitted or UL-SCH cannot be transmitted on the PUSCH. An indication field in DCI can be used to indicate whether all of the SRS resource(s) in the SRS resource set can be transmitted.

It should be understood that one or more features from the above implementation examples are not exclusive to the specific implementation examples, but can be combined in any manner (e.g., in any priority and/or order, concurrently or otherwise).

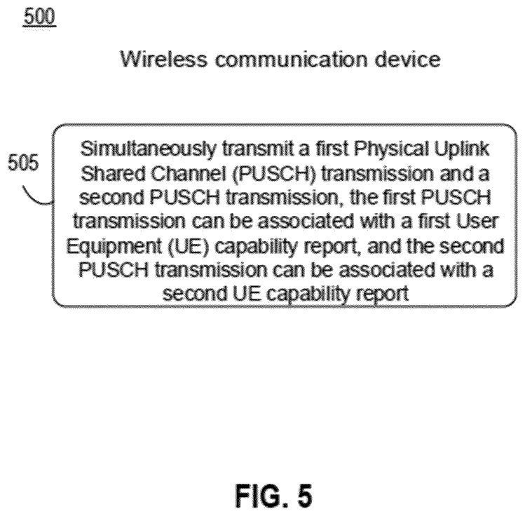

FIG. 5 illustrates a flow diagram of a method 500 for reporting capability of a user equipment (UE) for simultaneous physical uplink shared channel (PUSCH) transmission in multi-transmission reception point (TRP) operation. The method 500 may be implemented using any one or more of the components and devices detailed herein in conjunction with FIGS. 1-4. In overview, the method 500 may be performed by a wireless communication device (e.g., a UE), in some embodiments. Additional, fewer, or different operations may be performed in the method 500 depending on the embodiment. At least one aspect of the operations is directed to a system, method, apparatus, or a computer-readable medium.

A wireless communication device may simultaneously transmit a first Physical Uplink Shared Channel (PUSCH) transmission and a second PUSCH transmission. The first PUSCH transmission can be associated with a first User Equipment (UE) capability report. The second PUSCH transmission can be associated with a second UE capability report.

In some embodiments, the first PUSCH transmission and second PUSCH transmission can be associated with different transmission layers, respectively. In some embodiments, the first PUSCH transmission and second PUSCH transmission can be fully or partially overlapped with each other in at least one of a frequency domain or a time domain. In some embodiments, each of the first PUSCH transmission and second PUSCH transmission can be associated with a respective beam state or a respective spatial relation. In some embodiments, each of the first PUSCH transmission and second PUSCH transmission can be associated with a respective Sounding Reference Signal (SRS) resource set.

In some embodiments, the first PUSCH transmission and second PUSCH transmission can be associated with one or more identical transmission layers or identical Demodulation Reference Signal (DMRS) ports. In some embodiments, the first PUSCH transmission and second PUSCH transmission can be fully or partially overlapped with each other in at least one of a frequency domain or a time domain. In some embodiments, each of the first PUSCH transmission and second PUSCH transmission can be associated with a respective beam state or a respective spatial relation. In some embodiments, each of the first PUSCH transmission and second PUSCH transmission can be associated with a respective Sounding Reference Signal (SRS) resource set. Each of the first PUSCH transmission and second PUSCH transmission can be configured as a codebook-based PUSCH transmission.

In some embodiments, the first UE capability report may comprise at least one of: a value of a maximum transmission layer for the first PUSCH transmission, a number of antenna ports for the first PUSCH transmission, a maximum number of SRS resources per SRS resource set for the first PUSCH transmission, a mode of UL full power transmission for the first PUSCH transmission, or a maximum coherence of antenna ports for the first PUSCH transmission. The second UE capability report may comprise at least one of: a value of a maximum transmission layer for the second PUSCH transmission, a number of antenna ports for the second PUSCH transmission, a maximum number of SRS resources per SRS resource set for the second PUSCH transmission, a mode of UL full power transmission for the second PUSCH transmission, or a maximum coherence of antenna ports for the second PUSCH transmission.

In some embodiments, each of the first PUSCH transmission and second PUSCH transmission can be configured as a non-codebook-based PUSCH transmission. The first UE capability report may comprise at least one of: a value of a maximum transmission layer for the first PUSCH transmission, a maximum number of SRS resources per SRS resource set for the first PUSCH transmission, or a maximum number of simultaneous transmitted SRS resources at one symbol for the first PUSCH transmission. The second UE capability report may comprise at least one of: a value of a maximum transmission layer for the second PUSCH transmission, a maximum number of SRS resources per SRS resource set for the second PUSCH transmission, or a maximum number of simultaneous transmitted SRS resources at one symbol for the second PUSCH transmission.

In some embodiments, the first UE capability report may comprise at least one of: a value of a maximum transmission layer for the first or second PUSCH transmission, a combination value of maximum transmission layers for the first and second PUSCH transmissions, a number of antenna ports for the first or second PUSCH transmission, a combination number of antenna ports for the first and second PUSCH transmissions, a maximum number of SRS resources per SRS resource set for the first or second PUSCH transmission, a mode of UL full power transmission for the first or second PUSCH transmission, or a maximum coherence of antenna ports for the first or second PUSCH transmission. The second UE capability report may comprise at least one of: a value of a maximum transmission layer for the first or second PUSCH transmission, a combination value of maximum transmission layers for the first and second PUSCH transmissions, a number of antenna ports for the first or second PUSCH transmission, a combination number of antenna ports for the first and second PUSCH transmissions, a maximum number of SRS resources per SRS resource set for the first or second PUSCH transmission, a mode of UL full power transmission for the first or second PUSCH transmission, or a maximum coherence of antenna ports for the first or second PUSCH transmission.

In some embodiments, the first UE capability report may comprise at least one of: a value of a maximum transmission layer for the first or second PUSCH transmission, a combination value of maximum transmission layers for the first and second PUSCH transmissions, a maximum number of SRS resources per SRS resource set for the first or second PUSCH transmission, a maximum number of simultaneous transmitted SRS resources at one symbol for the first or second PUSCH transmission, or a combination value of maximum number of simultaneous transmitted SRS resources at one symbol for the first or second PUSCH transmission. The second UE capability report may comprise at least one of: a value of a maximum transmission layer for the first or second PUSCH transmission, a combination value of maximum transmission layers for the first and second PUSCH transmissions, a maximum number of SRS resources per SRS resource set for the first or second PUSCH transmission, a maximum number of simultaneous transmitted SRS resources at one symbol for the first or second PUSCH transmission, or a combination value of maximum number of simultaneous transmitted SRS resources at one symbol for the first or second PUSCH transmission.

In some embodiments, the wireless communication device may send at least one of the first UE capability report or the second UE capability report to a wireless communication node. The sent first or second UE capability report may indicate or can be associated with at least one of: an uplink TCI state associated with a CSI-RS set; a parameter “resourceType” of a corresponding SRS resource being set to “aperiodic,” “semi-persistent,” or “periodic;” an indication field of a DCI indicative of whether to transmit a corresponding SRS resource or PUSCH transmission; or an indication field of a DCI indicative of whether to transmit all SRS resources in a corresponding SRS resource set.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
simultaneously transmitting, by a wireless communication device, a first Physical Uplink Shared Channel (PUSCH) transmission and a second PUSCH transmission,
wherein the first PUSCH transmission is associated with a first User Equipment (UE) capability report, and the second PUSCH transmission is associated with a second UE capability report.

2. The wireless communication method of claim 1, wherein the first PUSCH transmission and second PUSCH transmission are associated with different transmission layers, respectively, or wherein the first PUSCH transmission and second PUSCH transmission are associated with same Demodulation Reference Signal (DMRS) ports, or wherein the first PUSCH transmission and second PUSCH transmission can be fully or partially overlapped with each other in at least one of a frequency domain or a time domain, or wherein each of the first PUSCH transmission and second PUSCH transmission is associated with a respective beam state or a respective spatial relation, or wherein each of the first PUSCH transmission and second PUSCH transmission is associated with a respective Sounding Reference Signal (SRS) resource set.

3. The wireless communication method of claim 1, wherein the first PUSCH transmission and second PUSCH transmission are associated with one or more identical transmission layers or identical Demodulation Reference Signal (DMRS) ports, or wherein the first PUSCH transmission and second PUSCH transmission can be fully or partially overlapped with each other in at least one of a frequency domain or a time domain, or wherein each of the first PUSCH transmission and second PUSCH transmission is associated with a respective beam state or a respective spatial relation, or wherein each of the first PUSCH transmission and second PUSCH transmission is associated with a respective Sounding Reference Signal (SRS) resource set.

4. The wireless communication method of claim 1. wherein the wireless communication device is configured with two Sounding Reference Signal (SRS) resource sets, and usage is set to ‘codebook’ or set to ‘noncodebook’.

5. The wireless communication method of claim 1, wherein the first UE capability report comprises at least one of: a value of maximum transmission layers for the first PUSCH transmission, a maximum number of antenna ports for the first PUSCH transmission, a maximum number of SRS resources per SRS resource set for the first PUSCH transmission, a mode of UL full power transmission for the first PUSCH transmission, or a maximum coherence of antenna ports for the first PUSCH transmission.

6. The wireless communication method of claim 5, wherein:
for single transmission reception point (STRP) transmission mode, the value of maximum transmission layers is at least one of 1, 2, 3, or 4; or
for spatial domain modulation (SDM) transmission mode, the value of maximum transmission layers is 1 or 2; or
for the STRP transmission mode or the SDM transmission mode, the value of maximum number of antenna ports is 1, 2, or 4; or
for the STRP transmission mode or SDM transmission mode, the value of maximum number of SRS resources per SRS resource set is at least one of 1, 2, 3, or 4.

7. The wireless communication method of claim 5, wherein:
for single transmission reception point (STRP) transmission mode, the value of maximum transmission layers is at least one of 1, 2, 3, or 4; or
for single frequency network (SFN) transmission mode, the value of maximum transmission layers is 1 or 2; or
for the STRP transmission mode or the SFN transmission mode, the value of maximum number of antenna ports is 1, 2, 3, or 4; or
for the STRP transmission mode or the SFN transmission mode, the value of maximum number of SRS resources per SRS resource set is at least one of 1, 2, 3, or 4.

8. The wireless communication method of claim 5, wherein:
for spatial domain modulation (SDM) transmission mode, the value of maximum transmission layers is 1 or 2; or
for the SDM transmission mode, a combination of maximum transmission layers is at least one of {1+1}, {1+2}, {2+1}, or {2+2}; or
for the SDM transmission mode, a combination of antenna ports is at least one of: {1+1}, {1+2}, {2+1}, {2+2}, {1+4}, {4+1}, {2+4}, {4+2}, or {4+4}; or
for the SDM transmission mode, the value of maximum number of simultaneous transmitted SRS resources at one symbol is 1, 2, 3, or 4; or
for the SDM transmission mode, a combination of maximum number of simultaneous transmitted SRS resources at one symbol is at least one of: {1+1}, {1+2}, {2+1}, {2+2}, {1+4}, {4+1}, {2+4}, {4+2}, or {4+4}.

9. The wireless communication method of claim 5, wherein:
for single frequency network (SFN) transmission mode, a combination of maximum transmission layers is at least one of {1+1} or {2+2}; or
for the SFN transmission mode, a combination of antenna ports is at least one of: {1+1}, {1+2}, {2+1}, {2+2}, {1+4}, {4+1}, {2+4}, {4+2}, or {4+4}.

10. The wireless communication method of claim 5, wherein:
for spatial domain modulation (SDM) transmission mode, the combination of maximum transmission layers is at least one of {1+1} or {2+2}; or
for the SDM transmission mode, the combination of maximum number of simultaneous transmitted SRS resources at one symbol is at least one of {1+1} or {2+2}.

11. The wireless communication method of claim 1, wherein the first UE capability report comprises at least one of: a value of maximum transmission layers for the first PUSCH transmission, a maximum number of SRS resources per SRS resource set, or a maximum number of simultaneous transmitted SRS resources at one symbol.

12. The wireless communication method of claim 11, wherein:
for single transmission reception point (STRP) transmission mode, the value of maximum transmission layers is at least one of 1, 2, 3, or 4; or
for the STRP transmission mode or SDM transmission mode, the value of maximum number of SRS resources per SRS resource set is at least one of 1, 2, 3, or 4; or
for the STRP transmission mode or SDM transmission mode, the value of maximum number of simultaneous transmitted SRS resources at one symbol is 1, 2, 3, or 4, or the value of maximum number of simultaneous transmitted SRS resources at one symbol for one SRS resource set is different from that of another SRS resource set.

13. The wireless communication method of claim 1, wherein the second UE capability report comprises at least one of: a value of a maximum transmission layer for the second PUSCH transmission, a maximum number of antenna ports for the second PUSCH transmission, a maximum number of SRS resources per SRS resource set for the second PUSCH transmission, a mode of UL full power transmission for the second PUSCH transmission, or a maximum coherence of antenna ports for the second PUSCH transmission.

14. A wireless communication method, comprising:
simultaneously receiving, by a wireless communication node from a wireless communication device, a first Physical Uplink Shared Channel (PUSCH) transmission and a second PUSCH transmission,
wherein the first PUSCH transmission is associated with a first User Equipment (UE) capability report, and the second PUSCH transmission is associated with a second UE capability report.

15. A wireless communication node, comprising:
at least one processor and a transmitter configured to:
simultaneously receive, from a wireless communication device, a first Physical Uplink Shared Channel (PUSCH) transmission and a second PUSCH transmission,
wherein the first PUSCH transmission is associated with a first User Equipment (UE) capability report, and the second PUSCH transmission is associated with a second UE capability report.

16. A wireless communication device, comprising:
at least one processor and a transmitter configured to:
simultaneously transmit, to a wireless communication node, a first Physical Uplink Shared Channel (PUSCH) transmission and a second PUSCH transmission,
wherein the first PUSCH transmission is associated with a first User Equipment (UE) capability report, and the second PUSCH transmission is associated with a second UE capability report.

17. The wireless communication device of claim 16, wherein the first PUSCH transmission and second PUSCH transmission are associated with different transmission layers, respectively, or wherein the first PUSCH transmission and second PUSCH transmission are associated with same Demodulation Reference Signal (DMRS) ports, or wherein the first PUSCH transmission and second PUSCH transmission can be fully or partially overlapped with each other in at least one of a frequency domain or a time domain, or wherein each of the first PUSCH transmission and second PUSCH transmission is associated with a respective beam state or a respective spatial relation, or wherein each of the first PUSCH transmission and second PUSCH transmission is associated with a respective Sounding Reference Signal (SRS) resource set.

18. The wireless communication device of claim 16, wherein the first PUSCH transmission and second PUSCH transmission are associated with one or more identical transmission layers or identical Demodulation Reference Signal (DMRS) ports, or wherein the first PUSCH transmission and second PUSCH transmission can be fully or partially overlapped with each other in at least one of a frequency domain or a time domain, or wherein each of the first PUSCH transmission and second PUSCH transmission is associated with a respective beam state or a respective spatial relation, or wherein each of the first PUSCH transmission and second PUSCH transmission is associated with a respective Sounding Reference Signal (SRS) resource set.

19. The wireless communication device of claim 16, wherein the wireless communication device is configured with two Sounding Reference Signal (SRS) resource sets, and usage is set to ‘codebook’ or set to ‘noncodebook’.

20. The wireless communication device of claim 16, wherein the first UE capability report comprises at least one of: a value of maximum transmission layers for the first PUSCH transmission, a maximum number of antenna ports for the first PUSCH transmission, a maximum number of SRS resources per SRS resource set for the first PUSCH transmission, a mode of UL full power transmission for the first PUSCH transmission, or a maximum coherence of antenna ports for the first PUSCH transmission.
